(19) United States
(12) Patent Application Publication
(10) Pub. No.: US 2012/0156938 A1
(43) Pub. Date: Jun. 21, 2012

(54) PLUG CONNECTOR WITH IMPROVED CIRCUIT CARD TO LOWER CROSS-TALKING THEREIN

(75) Inventor: George Huanyi Zhang, Irvine, CA (US)

(73) Assignee: HON HAI PRECISION INDUSTRY CO., LTD., Tu-Cheng (TW)

(21) Appl. No.: 12/972,434

(22) Filed: Dec. 18, 2010

(51) Int. Cl. H01R 24/00

(52) U.S. Cl. 439/660

(57) ABSTRACT

An electrical connector includes an insulating seat loaded with a circuit card therein. The circuit card includes a mating end intended to engage with a complementary connector and a terminal end intended to connect with cables. The mating end includes a row of conductive pad exploding to a first surface thereof. The row of conductive pad includes grounding pads and pairs of differential signal pads between every two of the grounding pads. The terminal end includes a row of conductive pads corresponding connected with the conductive pads of the mating end. The circuit card further is embedded a single piece grounding bar spacing apart from the row of the conductive pads with a gap and connected with the grounding pads of the row of the conductive pads.

### CROSS-REFERENCE TO RELATED APPLICATION

This application is related to a co-pending U.S. patent application, application Ser. No. 12/939,156, entitled “ELECTRICAL CONNECTOR WITH GROUNDING BARS THEREIN TO REDUCE CROSS TALKING”, wherein the application inventor is GEORGE HUANYI ZHANG and GUSTAVO F. DUENAS. The above application has the same assignee as the present application and has been currently filed herewith. The disclosure of the above application is incorporated here by reference.

### BACKGROUND OF THE INVENTION

1. Field of the Invention

The present invention relates to an electrical connector, and more particularly to an electrical connector capable of high speed and backwards compatibility with relative lower high speed.

2. Description of Related Art

Serial Attached SCSI (SAS) is a successor to the parallel SCSI and is also based on serial technology. Besides the advantage of higher speed signal transmission, another most significant advantage is that the SAS interface will also be compatible with SATA drives. In other words, the SATA plug connector can plug directly into a SAS receptacle connector if supported in the system. By this way, the system builders are flexible to integrate either SAS or SATA devices and slash the costs associated with supporting two separate interfaces.

U.S. Pat. No. 6,942,524 discloses a SAS connector for SAS 2.0 standard transmitting 6.0 Gbps. Higher signal transmission is a tendency in high speed industry. Connectors adapted for speed higher than 6.0 Gbps is developing. Questions of electrical performance, such as cross talk, signal attenuation arises. Particularly, crosstalk is a major issue at 12 Gbps. So, it's hoped to design an electrical connector to overcome said question.

Corresponding, cable end connectors, i.e. SAS plug connector mating with the SAS connector is also required to design.

### SUMMARY OF THE INVENTION

An object of the present invention is to provide to provide an electrical connector to reduce cross-talking.

In order to achieve above-mentioned object, an electrical connector comprises an insulating seat loaded with a circuit card therein. The circuit card comprises a mating end intended to engage with a complementary connector and a terminal end intended to connect with cables. The mating end comprises a row of conductive pad exploding to a first surface thereof. The row of conductive pad comprises grounding pads and pairs of differential signal pads between every two of the grounding pads. The terminals end comprises a row of conductive pads corresponding connected with the conductive pads of the mating end. The circuit card further is embedded a single piece grounding bar spacing apart from the row of the conductive pads with a gap and connected with the grounding pads of the row of the conductive pads.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a perspective front view of an electrical connector in accordance with the present invention;

FIG. 2 is a perspective view of the electrical connector assembled with a board-mounted complementary connector;

FIG. 3 is an exploded perspective view of the electrical connector and the complementary connector;

FIG. 4 is an exploded perspective view of the electrical connector and the complementary connector;

FIG. 5 is an exploded perspective view of the electrical connector;

FIGS. 6(a) and 6(b) are perspective views of a circuit card of the electrical connector in two views;

FIG. 7 is a perspective view of the conductive pads and grounding bars;

FIG. 8 is an exploded perspective view of the conductive pads and grounding bars; and

FIG. 9 is a front elevational view of the conductive pads and grounding bars.

### DETAILED DESCRIPTION OF THE INVENTION

Reference will now be made to the drawing figures to describe the preferred embodiment of the present invention in detail.

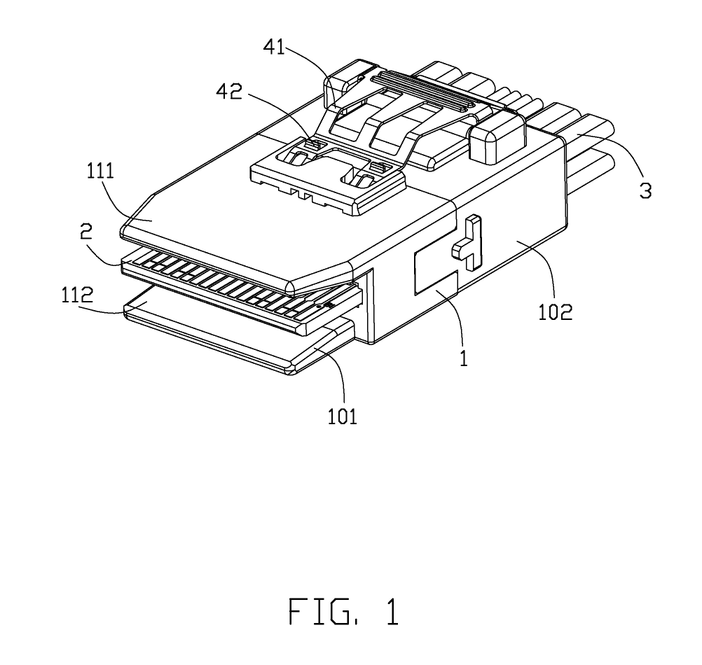

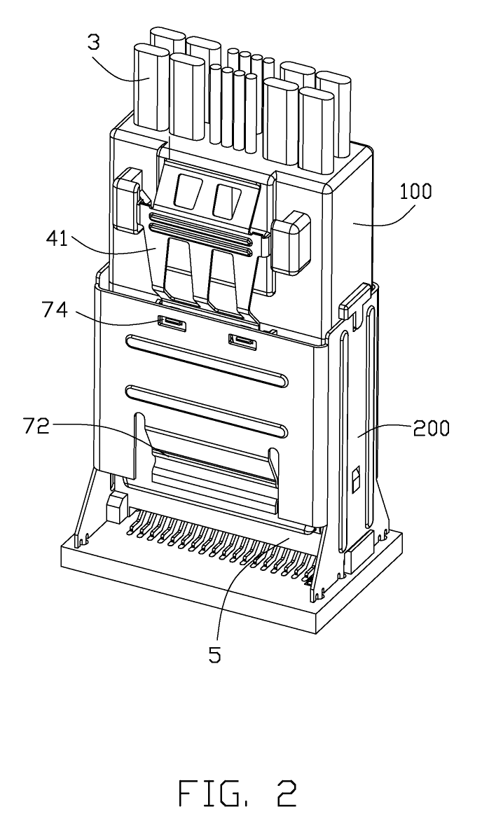

FIGS. 1 to 2 illustrate an electrical connector 100 made in accordance with the present invention, which is of plug cable type to mate with a receptacle board complementary connector 200 and used to exchange electrical signals. The electrical connector 100 include a mating portion 101 at a front side which is intended to be inserted into a receiving cavity surrounded by a frame shielding shell 7 of the complementary connector 200, and a body portion 102 connecting with pairs of cables 3. The mating portion 101 has three parallel spaced blades, a circuit card 2 and two insulating blade 111, 112 at two sides of the circuit card 2.

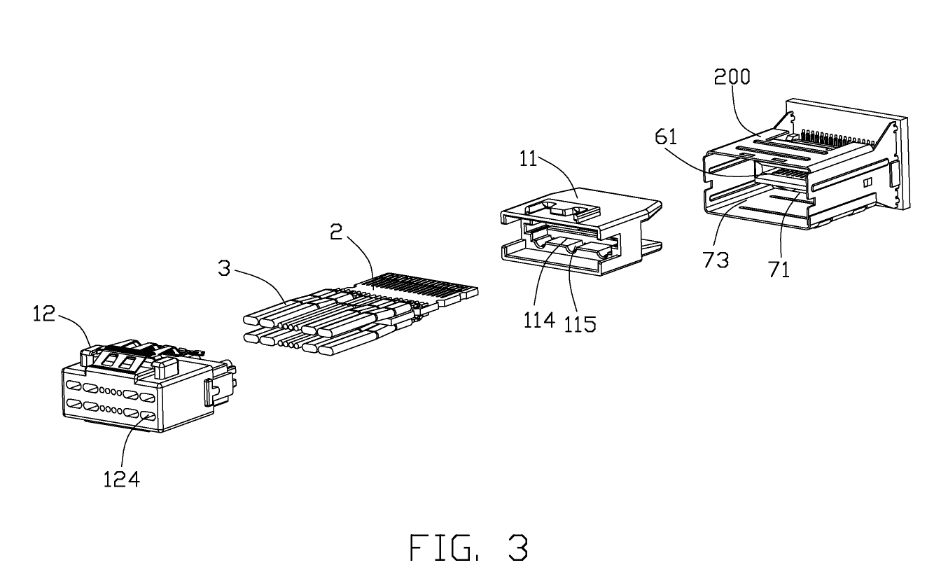

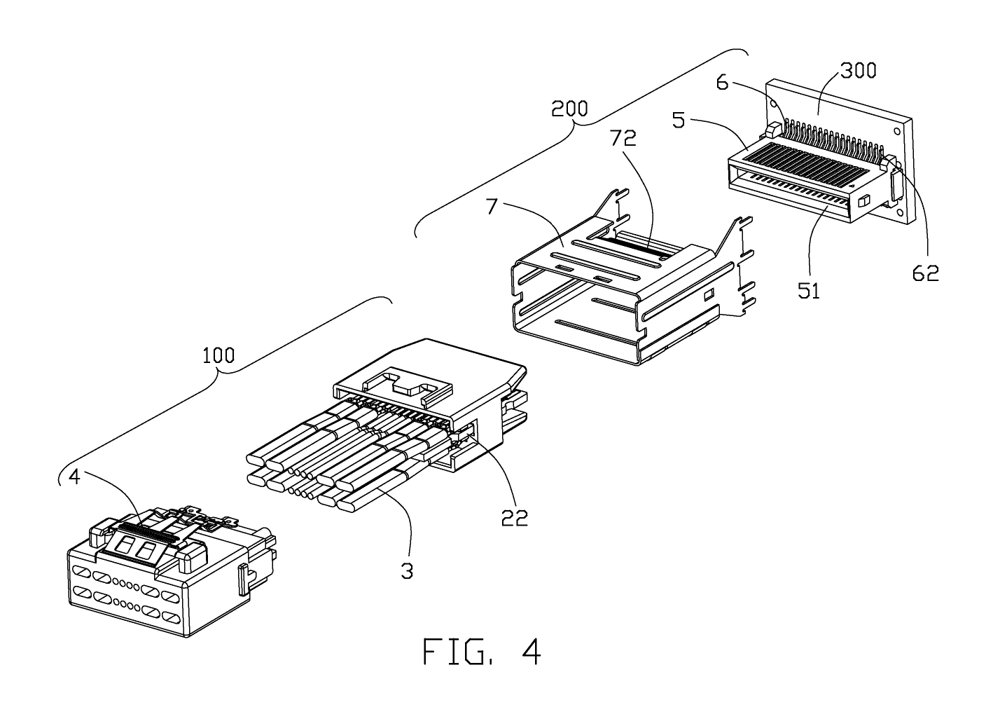

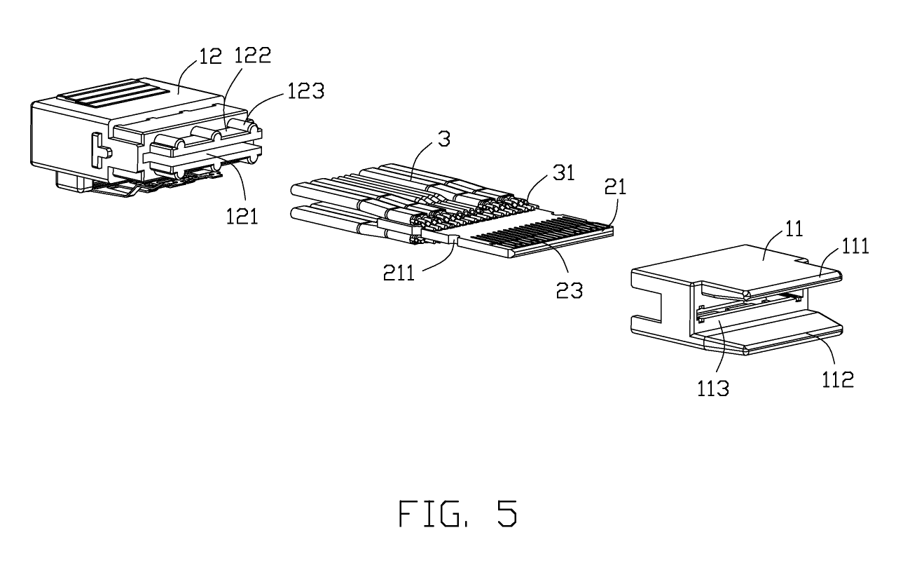

As shown in FIGS. 3 and 4, the complementary connector 200 includes an insulating seat 5 with a mating slot 51, a plurality of conductive terminals 6 with contacting portions 61 exploding to the mating slot 51 and soldering portions 62 soldered to the PCB 300, and said shielding shell 7. The shielding shell 7 has a lower portion surrounding the insulating seat 5 with gaps at two opposite surfaces of the insulating housing to form a first receiving cavity 71. Two spring arms 72 extending downwards as clearly shown in FIG. 2 press against outer surfaces of the insulating seat 5. The shielding shell 7 further includes an upper portion located above the insulating seat 5 to define a second receiving cavity 73. The mating portion 101 are inserted to the lower portion of the shell, wherein the circuit card 2 is inserted in the mating slot 51 and the lower and upper blades 111, 112 are inserted first receiving cavity 71, which are between the shell 7 and the outer surfaces of the insulating seat 5. The front portion of the body portion 102 is received in the second receiving cavity 73.

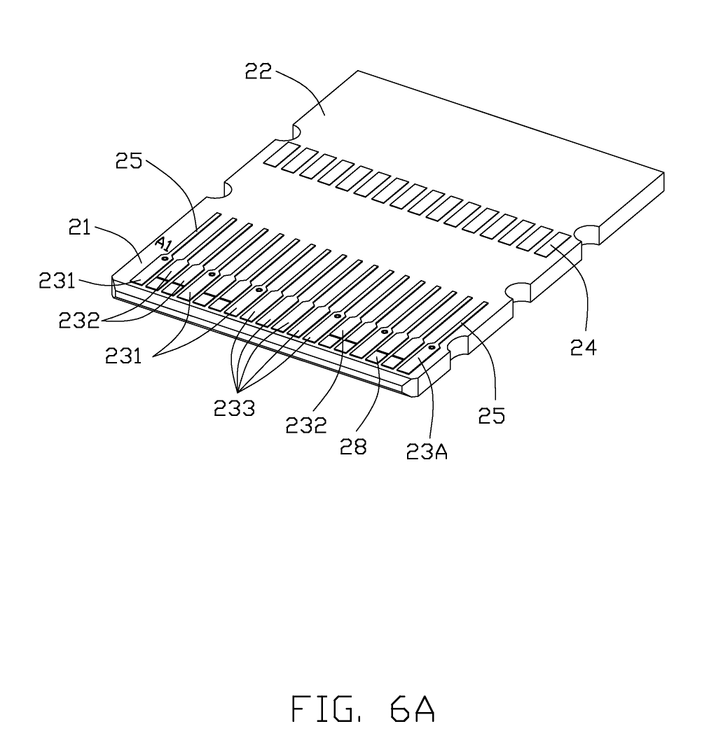

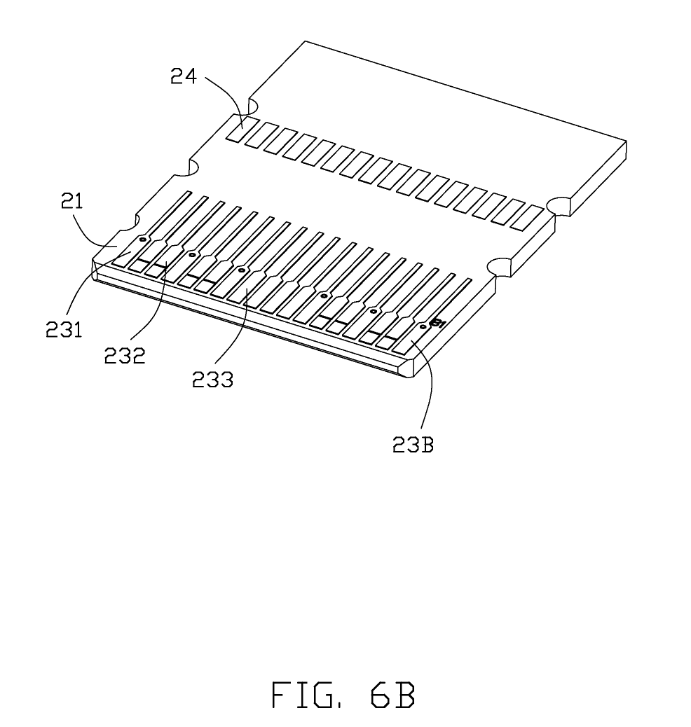

Referring to FIG. 5 combination with FIGS. 3 and 4, the electrical connector 100 includes an insulating seat 1 (labeled in FIG. 1) which includes a front insulating body 11 and a rear insulating body 12 assembled together, and said circuit card 2 connecting with said cables 3. The front body 11 extends said parallel spaced blades 111, 112 from opposite edges of a mating face 113 of the complementary connector 200, the mating face 113 intended to confront with a front face of the insulating seat 5 of the complementary connector 200. A retained groove 114 opens through the mating face 113 and a rear face opposite to the mating face of the front body 11. The circuit card 2 is retained in the retained groove by notches 211 at opposite sides thereof engaging with cam (not shown) in the retained groove 114, so the front end of the circuit card 2 projecting forward the mating face 113 is disposed parallel to and spacing from the blades, defined as a mating end 21 thereof. A rear end of the circuit card 2 exposes to the rear face of the front insulating body 11, defined as a terminal end 22 as labeled in FIG. 4. The conductive pads 24 labeled in FIG. 6 arranged along the terminal end 22 of the circuit card 2 are connected with conductive wires 31 of the cables 3 correspondingly.

The rear insulating body 12 defines a receiving groove 121 running through a front face thereof and through the rear face thereof with holes 124 to contain the cables 3. The front engaging portion 122 of the rear insulating body is just engaging with the rear portion of the front insulating body 11 wherein a plurality of semicircle ribs 123 at the engaging portion are contained in semicircle recesses 115 at the rear portion of the front insulating body 11 so that insulating seat 1 is formed. A metal latch 4 is retained on a surface of the rear insulating body, as best shown in FIGS. 1 and 2, the metal latch 4 define a spring arm 41 extending forwards, which defines a pair of retaining tabs 421 extending perpendicular to the outer face of the insulating seat 1 so that the retaining tabs will latch two slits 74 defined on the upper portion of the shielding shell 7 of the complementary connector 200.

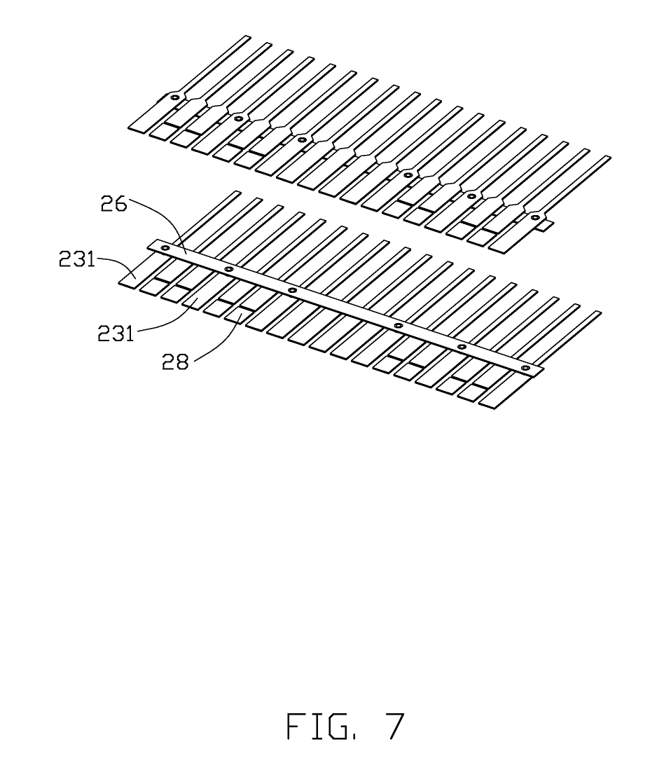

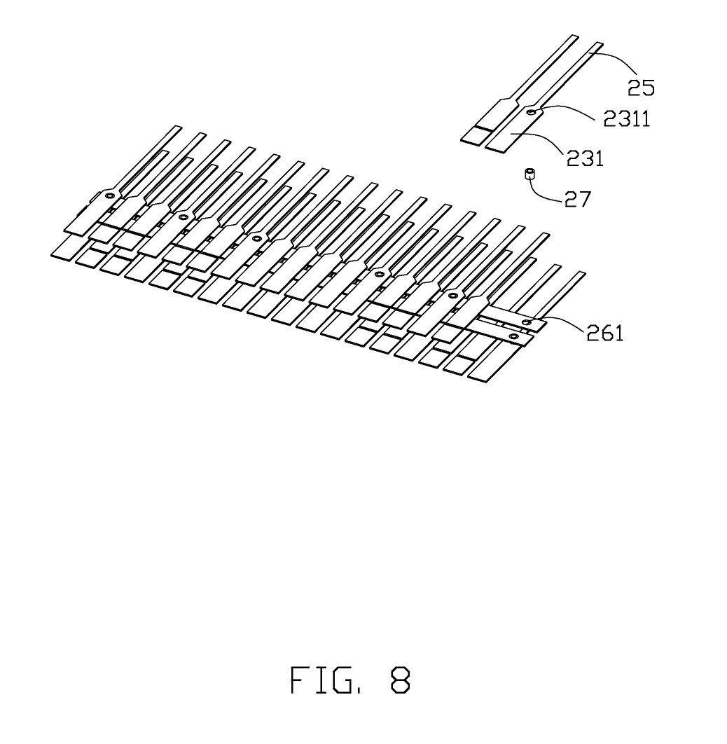

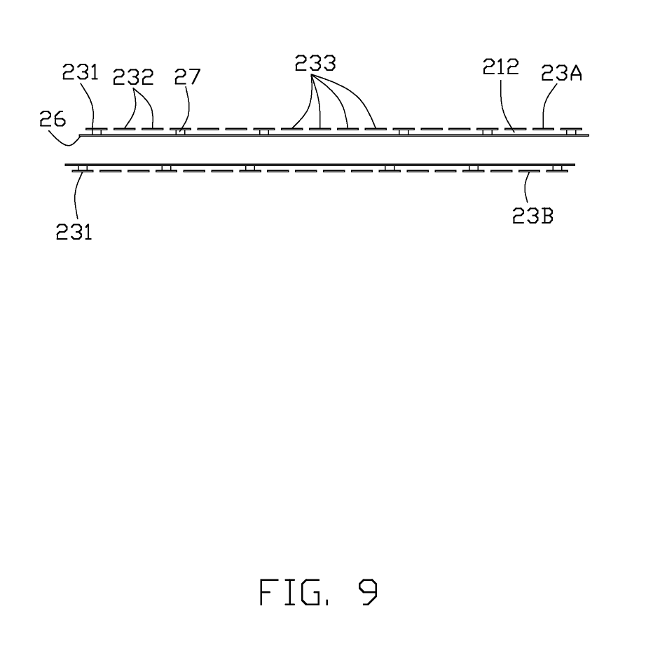

Referring to FIGS. 6(a) and 6(b), the mating end 21 of the circuit card 2 is intended to electrically connect with the conductive terminals 6 of the complementary connector 200 and the terminal end 22 connecting with the cables 3. The circuit card has two rows conductive pads 23A, 23B respectively exploding to two surfaces A1, B1 (labeled at corners of the circuit card) of mating end 21. Similarly, two rows of conductive pads 24 are arranged at two surfaces of the terminal end 21 of the circuit card 2. The corresponding conductive pads 23, 24 on the mating end 21 and the terminals end 22 are connected with each other by circuit traces 25 one by one. The conductive pads 23A of the mating end on the first surface A1 are arranged offsetting from that of the mating end on the second surface B1 as best shown in FIG. 9, while the pattern of the pads are same. A description of the pattern of the conductive pads is given below. The conductive pads includes six grounding pads 231, four pairs of 232 differential signal pads 232 between every two of the grounding pads 231 and four other function pads 233 such as sideband pads at the central of the row of the conductive pads 23A. The use of the sideband pad signals by a controller is vendor-specific. FIG. 7 shows the circuit card 2 removing the insulating body to clearly illustrate the conductive pads 23, wherein it's best show that two one-single-piece grounding bars 26 are embed in the insulating body of the circuit card. Combination with FIGS. 8 and 9, the grounding bars transverse the rows the conductive pads 23A, 23B of the mating end 21 with a gap 212 and connected with the grounding pads via metal linking members 27, such as rivets. The grounding pads 231 each are disposed with a hole 2311 adjacent to the terminal joint with the circuit trace 25. The grounding bar 26 defines six holes 261 aligned with the holes 2311 of the grounding pads 231. The rivets 27 are received and retained the holes 2311, 261 of the grounding pads and grounding bar at two ends thereof.

The signal pads 232 are shorter than the grounding pads 231 and the other function pads 233 in a recessed fashion, for hot plug able in SATA spec. The circuit card 2 have a metal pad 28 in front of each signal pad 232 so that all conducive pads at a same level, which benefit to keep the surface properties along the whole of the mating end for durability and increase the wipe length for cleaning the conductive pads' surfaces.

However, the disclosure is illustrative only, changes may be made in detail, especially in matter of shape, size, and arrangement of parts within the principles of the invention.

What is claimed is:

1. An electrical connector comprising:
an insulating seat loaded with a circuit card therein.
the circuit card comprising a mating end intended to engage with a complementary connector and a terminal end intended to connect with cables, the mating end comprising a row of conductive pad exposed upon a first surface thereof;
the row of conductive pad comprising grounding pads and pairs of differential signal pads between every two of the grounding pads, the terminal end comprising a row of conductive pads corresponding connected with the conductive pads of the mating end;
wherein the circuit card further is embedded a single piece grounding bar spacing apart from the row of the conductive pads with a gap and connected with the grounding pads of the row of the conductive pads.

2. The electrical connector as described in claim 1, wherein the grounding pads are connected with the grounding bar by metal linking members.

3. The electrical connector as described in claim 2, wherein the grounding pads each define a hole therein and the grounding bar defines holes aligned with the holes of the grounding pads, the metal linking members are of rivets which are received and retained in the holes of the grounding pads and grounding bar at opposite ends thereof.

4. The electrical connector as described in claim 3, wherein the insulating seat extends two parallel blades at two sides of the mating end of the circuit card, which space apart from the circuit card.

5. The electrical connector as described in claim 4, wherein the circuit card is retained in a front insulating body of the insulating seat with the terminal end of the circuit body exposing to a rear face of the front insulating body, a rear insulating body is attach to the front insulating body and surrounds the terminal end of the circuit board.

6. The electrical connector as described in claim 5, wherein the holes of the grounding pads are adjacent to terminal joints with circuit traces connecting with the conductive pads of the mating end and the terminal end.

7. The electrical connector as described in claim 6, wherein the circuit card at a second surface opposite to the first surface also comprises a row of conductive pads and a grounding bar same to that in the first surface thereof, the conductive pads in the second surface offset from that in the first surface of the circuit board.

8. The electrical connector as described in claim 1, wherein the signal pads are shorter than the grounding pads in a recessed fashion, the circuit card have a metal pad in front of each signal pad so that all conducive pads at a same level.

9. An electrical connector comprising:
a housing;
a printed circuit board enclosing in the housing and defining a mating face thereon;
a plurality of grounding pads and a plurality of differential pair pads alternative arranged on the mating face in a transverse direction, each of said grounding pads and said differential pair pads extending along a front-to-back direction perpendicular to said transverse direction; and
a grounding bar embedded within the printed circuit board and closely said grounding pads and said differential pair pads with a tiny gap therebetween in a vertical direction perpendicular to said transverse direction and said front-to-back direction; wherein
a plurality of conductive members respectively linked between the grounding pads and the grounding bar and essentially embedded within the printed circuit board.

10. The electrical connector as claimed in claim 9, wherein the grounding bar essentially extends in said transverse direction.

11. The electrical connector as claimed in claim 9, wherein each of said grounding pads defines a front large section and a rear small section, and the corresponding conductive member is aligned with the large section in the vertical direction.

12. The electrical connector as claimed in claim 11, wherein said conductive member is located around an interface region between the front large section and the rear small section.

13. The electrical connector as claimed in claim 12, wherein said interface region defines a tapered configuration.

14. The electrical connector as claimed in 9, wherein said printed circuit board further includes a plurality of connection pads located behind said grounding pads and said differential pair pads, respectively, and a plurality of cables are connected to the corresponding connection pads, respectively.

15. The electrical connector as claimed in claim 9, wherein said housing is insulative.

16. An electrical connector comprising:
a housing;
a printed circuit board enclosing in the housing and defining a mating face thereon;
a plurality of grounding pads and a plurality of differential pair pads alternative arranged on the mating face in a transverse direction, each of said grounding pads and said differential pair pads extending along a front-to-back direction perpendicular to said transverse direction, each of said grounding pads defining a front large section and a rear small section with a tapered transition area therebetween; and
a grounding device hidden under the mating surface, crosses said grounding pads and said differential pair pads with linking structures respectively mechanically and electrically connected to the corresponding grounding pads around the corresponding transition areas.

17. The electrical connector as claimed in claim 16, wherein said linking structures extend perpendicular to the mating face.

18. The electrical connector as claimed in claim 17, wherein each of said linking structures is of a form of tube.

19. The electrical connector as claimed in claim 18, wherein said linking structure defines a round tube.
